(19) United States
(12) Patent Application Publication
(10) Pub. No.: US 2019/0188085 A1
(43) Pub. Date: Jun. 20, 2019

(54) PERSISTENTLY STORE CACHED DATA OF A WRITE TO A BLOCK DEVICE PRESENTATION

(71) Applicant: HEWLETT PACKARD ENTERPRISE DEVELOPMENT LP, Houston, TX (US)

(72) Inventors: Alastair Slater, Bristol (GB); Andrew Sparkes, Bristol (GB)

(21) Appl. No.: 15/842,123

(22) Filed: Dec. 14, 2017

(51) Int. Cl. G06F 11/14; G06F 17/30; G06F 3/06

(52) U.S. Cl. CPC G06F 11/1451; G06F 11/1453; G06F 11/1464; G06F 11/1471; G06F 2201/84; G06F 17/30088; G06F 3/0641; G06F 3/0619; G06F 11/1469

(57) ABSTRACT

Examples include the persistent storage of cached data of a write to a block device presentation. Some examples may include a block device presentation of data represented by first backup objects stored in a deduplication backup appliance, and may cause the deduplication backup appliance to store second backup objects representing the data stored in a cache for each transient write to the block device presentation.

### BACKGROUND

A client computing device, such as a host server or the like, may store data in a primary storage array, and may execute workloads against the data stored in the primary storage array. In some examples, the data stored in the primary storage array may be backed up in a backup appliance, separate from the client computing device and the primary storage array, for redundancy and data protection purposes, or the like. In some examples, the backup appliance may store data in a deduplicated form such that the data is stored more compactly than on the primary storage array.

### BRIEF DESCRIPTION OF THE DRAWINGS

The following detailed description references the drawings, wherein:

FIG. 1 is a block diagram of an example computing environment including a backup computing device to cause a deduplication backup appliance to store backup objects representing data stored in cache for transient write(s);

FIG. 2 is a block diagram of an example computing environment including a backup computing device to receive a request to persistently store the cached data of a transient write to a block device presentation;

FIG. 3 is a flowchart of an example method of a backup agent including causing a deduplication backup appliance to store backup objects representing data stored in cache for transient write(s); and

FIG. 4 is a flowchart of an example method of a backup agent including determining, based on data stored in a cache for transient writes, which data fingerprints from first backup objects to replace in second backup objects.

### DETAILED DESCRIPTION

A client computing device, such as a host server or the like, may access a data volume on a primary storage array when performing workloads associated with application(s) on the client computing device. The client computing device may also communicate with a backup computing device to perform backup related tasks, such as creating snapshots of the data volume on the primary storage array. The backup computing device may also act as an interface between the client computing device and a deduplication backup appliance that stores data backups in a deduplicated form.

For example, the client computing device may be able to instruct the backup computing device to create, on the deduplication backup appliance, a deduplicated backup copy of a data volume or snapshot stored on the primary array. The backup computing device may also enable the client computing device to recover data from the deduplicated backups. In some examples, the backup computing device may present the client computing device with a mountable block device presentation of a set of backup object(s) representing a data volume or snapshot that has been backed up to the deduplication backup appliance. In such examples, the client computing device may request portions of data from the block device presentation, and the backup computing device may be able to return those portions of data from the corresponding backup objects stored in the deduplication backup appliance. The backup computing device may also receive writes to the block device presentation from the client computing device, and may store the data of those writes in a cache at the backup computing device.

However, the changes included in those writes may not be applied to the backup objects behind the block device presentation. For example, backup objects may be held immutable for several reasons, such as compliance with legal regulations and maintaining the fidelity of the original backup objects. As such, the writes to the block device presentation may not be persistently maintained, and may be lost upon a restart or power cycle of the backup computing device.

To address these issues, examples described herein may make the cached writes to the block device presentation persistent by creating a new set of backup objects on the deduplication backup appliance that include representations of the cached writes to the block device presentation. In such examples, the new set of backup objects may be created from the first set of backup objects representing the data of the block device presentation before the writes, but with changes to reflect the changes in the cached data writes (i.e., with the data of the writes applied to the new backup objects).

In such examples, enabling writes to a block device presentation to be made persistent may allow the backup computing device to be more useful for live activities to be performed against the block device presentations. For example, workloads may be performed against the block device presentation at the backup computing device, and the results of those workloads on the data of the block device presentation may be stored persistently. In such examples, this may reduce the load on the primary storage array, by enabling the backup computing device to be more usefully used for performing workloads against a block device presentation, which does not utilize resources of a primary storage array, rather than against a volume or snapshot of a primary storage array.

For example, in examples described herein, a backup agent may receive, from a client computing device, at least one transient write including data to write to a block device presentation of data represented by first backup objects that include data representations and are stored in a deduplication backup appliance, and the backup agent may store, in a cache, the data received in each transient write to the block device presentation, wherein the block device presentation is presented to the client computing device by the backup agent. In some examples, the backup agent may receive, from the client computing device, a request to persistently store the data of the at least one transient write stored in the cache for the block device presentation, the request specifying how to persistently store the data. In some examples, when the request specifies to persistently store the data in new backup objects, the backup agent may cause the deduplication backup appliance to store second backup objects representing the data stored in the cache for each transient write, such that the second backup objects contain the same data representations as the first backup objects except where replaced by at least one data representation of data stored in the cache for a transient write.

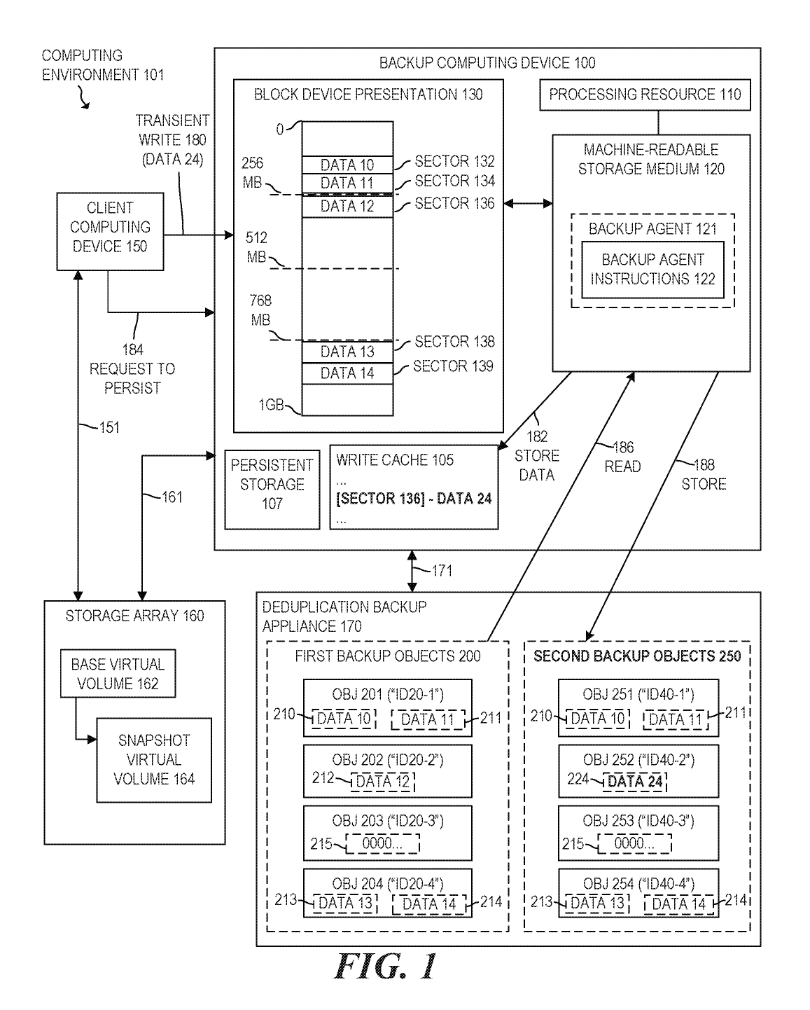

Referring now to the drawings, FIG. 1 is a block diagram of an example computing environment 101 including a backup computing device 100 to cause a deduplication backup appliance 170 to store backup objects representing data stored in cache for transient write(s). In the example of FIG. 1, a client computing device 150 may communicate with a storage array 160 via a suitable communications channel 151 to store data on and retrieve data from storage array 160. For example, storage array 160 may be a primary storage array for client computing device 150, and client computing device 150 may store data in and retrieve data from storage array 160 while executing workload(s), for example. In some examples, client computing device 150 may be a host server, or the like.

Client computing device 150 may also communicate with a backup computing device 100 to perform backup related tasks, such as creating snapshots of base virtual volume 162 on storage array 160. Backup computing device 100 may also act as an interface between client computing device 150 and a deduplication backup appliance 170 that stores data backups in a deduplicated form. In the example of FIG. 1, backup computing device 100 may be implemented by at least one computing device, which may include at least one physical network interface for communication on a computer network. Backup computing device 100 may include at least one processing resource 110, and at least one machine-readable storage medium 120 comprising (e.g., encoded with) backup agent instructions 122 that are executable by the at least one processing resource 110 of computing system 100 to at least partially implement functionalities of a backup agent 121, as described herein in relation to FIG. 1. In some examples, backup agent 121 may be implemented in a virtual machine implemented by backup computing device 100.

In the example of FIG. 1, client computing device 150 may provide backup agent 121 with a request to create a snapshot of base virtual volume 162, either at a given time or according to a schedule. In such examples, instructions 122, when executed, may instruct storage array 160 to generate a snapshot virtual volume 164 representing the base virtual volume 162 at a given point in time, such as when the snapshot was created. In some examples, backup computing device 100 may communicate with storage array 160 via a suitable communications channel 161.

In some examples, client computing device 150 may instruct backup agent 121 to create, on deduplication backup appliance 170, a deduplicated backup copy of a data volume or snapshot stored on the primary array. For example, client computing device 150 may instruct backup agent 121 to create a backup copy of snapshot virtual volume 164 on deduplication backup appliance 170. In such examples, instructions 122, when executed, may read snapshot virtual volume 164 from storage array 160, and cause deduplication backup appliance 170 to store first backup objects 200, representing snapshot virtual volume 164, on deduplication backup appliance 170.

In examples described herein, a “deduplication backup appliance” may be a computing device, such as a storage array or the like, that stores data in a deduplicated form. In the example of FIG. 1, deduplication backup appliance 170 may store a backup copy of a given set of data by storing one or more backup objects representing the given set of data. In some examples, each backup object for the given set of data may represent a respective contiguous range of the given set of data, and may comprise a plurality of data representations (e.g., data fingerprints such as hashes, or the like) for each chunk of data that makes up the respective contiguous range. For example, a process to deduplicate a given set of data for storage on deduplication backup appliance 170 may involve dividing the given set of data into fixed or variable sized chunks (which may be referred to herein as “chunking”). Chunk sizes may be, for example, 4 KB for fixed size chunks, or any other suitable size. The deduplication process may then involve deriving smaller data representations of the chunks, such as deriving a hash value (or “hash” herein) for each of the chunks, and then using those hashes to determine, for each chunk, whether the chunk of data has been encountered previously for a given store on the deduplication backup appliance 170 to which the set of data is being stored.

If a hash of a chunk has not already been encountered for the given store on the deduplication backup appliance 170, then the chunk will be stored on the deduplication backup appliance 170 and the hash will be placed in a backup object at a location representing where the corresponding chunk is located in the given set of data. If a hash of a chunk has already been encountered for the given store, then the chunk is considered a duplicate and is not stored again on the deduplication backup appliance 170, as it would be duplicative of a prior version of the chunk that will be stored on the deduplication backup appliance 170, but the hash of the chunk will still be placed in a backup object at a location representing where the corresponding chunk is located in the given set of data. In examples described herein, a hash or hash value is a value resulting from applying a suitable hash function to a chunk of data. Although examples are described herein in relation use of hashes as the data representations making up backup objects, any other suitable data representation may be used. For example, the data representations may be any suitable type of data fingerprints derived using any suitable type of data fingerprint function. For example, the data fingerprints may be hashes derived using a hash function, digital signatures derived using a digital signature function, or the like.

As described above, in the example of FIG. 1, instructions 122, when executed, may cause deduplication backup appliance 170 to store first backup objects 200, representing snapshot virtual volume 164, on deduplication backup appliance 170. In some examples, instructions 122 may implement client-side deduplication of the given set of data in which one or more of the chunking, hashing, and hash comparisons of the deduplication process are performed at the backup computing device 100, such that the full amount of data is not sent to deduplication backup appliance 170. In the example of FIG. 1, first backup objects 200 may represent snapshot virtual volume 164, with each of backup objects 201, 202, 203, and 204 representing a respective contiguous portion of the snapshot virtual volume 164, and each including data representations (e.g., hashes) of the chunks making up the contiguous region represented by the backup object. The chunks represented by the data representations (e.g., hashes) may themselves also be stored on the deduplication backup appliance 170 separate from the first backup objects 200, with duplicate chunks stored once for a given store, as described above. As used herein, a “store” of a deduplication backup appliance 170 may be a logical region of the deduplication backup appliance 170 used to store backup objects.

In the example of FIG. 1, backup agent 121 of backup computing device 100 may enable client computing device 150 to recover data from deduplicated backups (e.g., backup objects and chunks) stored on the deduplication backup appliance 170. In some examples, backup agent 121 may present client computing device 150 with a mountable block device presentation of a set of backup objects representing a data volume or snapshot that has been backed up to deduplication backup appliance 170. In the example of FIG. 1, backup agent 121 may present client computing device 150 with a mountable block device presentation 130 of the first backup objects 200 representing snapshot virtual volume 164 that has been backed up to deduplication backup appliance 170.

In examples described herein, a “block device presentation” may be an emulation of a block device including data represented by backup object(s). In some examples, a driver or other executable instructions of backup agent 121 may implement a block device presentation of backup objects by, for example, receiving communications from a client computing device targeting a block device, and providing responses emulating the corresponding responses of a block device. In some examples, the block device presentation (e.g., emulated block device implemented by a driver) may be mountable by a client computing device as if it were an actual block device. In such examples, the client computing device may request portions of data from the block device presentation as it would from an actual block device, and backup agent 121 may be able to return those portions of data from the corresponding backup objects (and chunks) stored in deduplication backup appliance 170.

In the example of FIG. 1, instructions 122, when executed, may present to client computing device 150 a block device presentation 130 of data represented by first backup objects 200, which include data fingerprints (e.g., at least data fingerprints 210-215) and which are stored in deduplication backup appliance 170. As noted above, the first backup objects 200 may represent a backup of snapshot virtual volume 164. As such, in the example of FIG. 1, the block device presentation 130 may be a block device presentation (e.g., emulated block device) of data of snapshot virtual volume 164, where the actual data of snapshot virtual volume 164 is represented by first backup objects 200 for the block device presentation 130.

In the example of FIG. 1, a 1 GB range of block device presentation 130 is shown for purposes of explanation (though it may have a smaller or larger range in other examples). In the example of FIG. 1, the block device presentation may be addressed by sectors, which may represent suitably sized portions of the block device presentation for addressing (e.g., 512 byte sectors). A first range of block device presentation 130, from 0 MB to 256 MB, includes at least data 10 in sector 132 and data 11 in sector 134, and is represented by backup object 201 of first backup objects 200. Backup object 201 includes at least a data representation 210 (e.g., data fingerprint, hash, etc.) of data 10 of the first range and a data representation 211 (e.g., data fingerprint, hash, etc.) of data 11 of the first range, and has an identifier “ID20-1”. A second range of block device presentation 130, from 256 MB to 512 MB, includes at least data 12 in sector 136, and is represented by backup object 202, which includes at least a data representation 212 of data 12 and has an identifier “ID20-2”. A third range of block device presentation 130, from 512 MB to 768 MB, includes no data in this example, and is represented by backup object 203, which includes at least a data representation 215 (e.g., a hash of zeros) and has an identifier “ID20-3”. A fourth range of block device presentation 130, from 768 MB to 1 GB, includes at least data 13 in sector 138 and data 14 in sector 139, and is represented by backup object 204, which includes at least a data representation 213 of data 13 and a data representation 214 of data 14, and has an identifier “ID20-4”. Although an example of block device presentation 130 is shown for illustrative purposes, block device presentation 130 may represent any suitable range and include more, less, or different data in other examples. Although first backup objects 200 includes four backup objects and are shown including certain data representations in the example of FIG. 1, in other examples, there may be more or fewer backup objects, which may include more, fewer, or different data representations.

In the example of FIG. 1, instructions 122, when executed, may communicate with client computing device 150 such that client computing device 150 may mount block device presentation 130. In such examples, instructions 122 of backup agent 121 may receive requests to read data from an addressed region of block device presentation. For example, in examples using sectors for addressing (as in the example of FIG. 1), instructions 122 may receive a request to read the data from sector 132. In such examples, instructions 122, when executed, may check a read cache (including data previously read from the block device presentation) and return the data if present in the read cache. If not present in the read cache, instructions 122 may retrieve the data corresponding to sector 132 from the first backup objects 200. For example, instructions 122 may retrieve the chunk(s) corresponding to the data representation 210 of backup object 201, which corresponds to the data in sector 132, and return that data (e.g., data 10) to the client computing device 150 in response to the request. In such examples, the block device presentation 130 presented by backup agent 121 enables client computing device 150 to access the data represented by the first backup object as if it were accessing a block device containing the backed up data.

In some examples, backup agent 121 may receive writes to block device presentation 130 from client computing device 150, and may store the data of those writes in a write cache 105 of backup computing device 100. However, as noted above, the changes included in those writes may not be applied to backup objects (e.g., first backup objects 200) representing the data of block device presentation 130. As noted above, backup objects may be held immutable for several reasons, such as compliance with legal regulations and maintaining the fidelity of the original backup objects. As such, the writes to block device presentation 130 held in write cache 105 may not be persistently maintained, and may be lost upon a restart or power cycle of backup computing device 100. To address these issues, examples described herein may make cached write(s) to block device presentation 130 persistent by creating a new set of backup objects on deduplication backup appliance 170 that include representations of the cached writes to the block device presentation.

Referring again to FIG. 1, instructions 122, when executed, may receive, from client computing device 150, a transient write 180 including data 24 to write to block device presentation 130 of data represented by the first backup objects 200, which include data representations (e.g., data representations 210-215, etc.) and are stored in deduplication backup appliance 170. In response to the received write, instructions 122, when executed, may store 182, in the write cache 105, the data 24 received in the transient write 180 to block device presentation 130. Although one such write is illustrated in FIG. 1 for explanatory purposes, instructions 122 may receive a plurality of transient writes 180 including data to write to block device presentation 130, and may store 182 the data 24 received in each transient write in the write cache 105.

In examples described herein, a “transient” write is a request to write data to a block device presentation, wherein the data of the request is not committed or otherwise applied to the backup objects representing the data presented in the block device presentation. As such, those writes only remain as long as the write cache 105 does not lose its data (e.g., by backup computing device 100 losing power, restarting, or the like), so those writes may be referred to herein as “transient” writes, with respect to the block device presentation. In some examples, instructions 122, when executed, do not apply (or cause the deduplication backup appliance 170 to apply) the data of any transient write to the first backup objects 200 at any time. As noted above, in some examples, backup objects may be held immutable for various reasons. In such examples, instructions 122, when executed, may never apply (or cause the deduplication backup appliance 170 to apply) the data of any transient write to the first backup objects 200 at any time.

In examples described herein, the write cache 105 may be implemented by any suitable hardware cache device(s), such as one or more volatile memory device(s), such as one or more volatile random-access memory (RAM) device(s) (e.g., dynamic random access memory (DRAM) device(s)), or the like.

In the example of FIG. 1, write cache 105 may store data of transient writes as writes to regions (e.g., sectors) of block device presentation 130. In such examples, a transient write may specify a sector of block device presentation 130 to write data of the transient write to, and instructions 122, when executed, may store the data of the transient write to the write cache 105 associated with (e.g., indexed by) the sector number. In the example of FIG. 1, for example, transient write 180 may include data 24 and specify that data 24 is to be written to sector 136 of block device presentation 130. In response to receiving that transient write, instructions 122, when executed, may store 182 data 24 in write cache 105 associated with (e.g., indexed by) sector 136. In this example, data 24 is written to overwrite data 12, which is already present in sector 136. However, instructions 122 do not overwrite data representation 212 of backup object 202 with a data representation (e.g., hash) of data 24, as described above. However, in response to a subsequent read of sector 136 received from client computing device 150, instructions 122, when executed, may return the data stored in write cache 105 for sector 136 (e.g., data 24) to client computing device 150.

In some examples, after storing data of at least one transient write in write cache 105, as illustrated in the example of FIG. 1, instructions 122, when executed, may receive, from client computing device 150, a request 184 to persistently store the data of the at least one transient write 180 stored in write cache 105 for block device presentation 130. In some examples, the request 184 may specify how to persistently store the data. When the request 184 specifies to persistently store the data of the write cache 105 in new backup objects, instructions 122, when executed, may cause deduplication backup appliance 170 to store 188 second backup objects 250 representing the data stored in the cache for each transient write, such that the second backup objects 250 contain the same data representations as first backup objects 200 except where replaced by at least one data representation of data stored in write cache 105 for a transient write. In the example of FIG. 1, second backup objects 250 may be created from, and as substantial copies of, first backup objects 200, but with the data of the transient write(s) stored in write cache 105 represented in second backup objects 250, and replacing the representations of the data written by the transient write(s).

For example, in an illustrative example in FIG. 1, write cache 105 may only include data of only one transient write, specifically data 24 of transient write 180. In such examples, instructions 122 may cause deduplication backup appliance 170 to create second backup objects 250 as substantial copies of first backup objects 200, but with a data representation 224 of data 24 (which is written by transient write 180) replacing the data representation 212 of data 12 (which is overwritten by transient write 180). In such examples, second backup object 250 may include an object 251 (with identifier “ID40-1”) that is an identical copy of the data representations of object 201 (including at least the illustrated data representations 210 and 211), and may include an object 252 (with identifier “ID40-2”) that is a substantial copy of the data representations of object 202, but with data representation 224 in object 252 replacing data representation 212 (from object 220). In such examples, second backup object 250 may further include an object 253 (with identifier “ID40-3”) that is an identical copy of the data representations of object 203 (including at least the illustrated data representation 215), and may include an object 254 (with identifier “ID40-4”) that is an identical copy of the data representations of object 204 (including at least the illustrated data representations 213 and 214),

Although an example is described above in which data of one transient write is represented in the second backup objects, instructions 122 may similarly cause deduplication backup appliance 170 to store second backup objects representing data of multiple transient writes stored in the cache.

For example, write cache 105 may contain data from a plurality of prior transient writes 180 when instructions 122 receive, from client computing device 150, the request 184 to persistently store the data of transient write(s) stored in write cache 105 for block device presentation 130 in new backup objects. In such examples, in response to the request, instructions 122, when executed, may cause deduplication backup appliance 170 to store second backup objects 250 as substantial copies of the first backup objects, having the same data representations (e.g., data fingerprints) as the first backup objects, except where the data representations are replaced in the second backup objects with representations of data of the transient writes stored in write cache 105.

In some examples, instructions 122, when executed, may cause the deduplication backup appliance 170 to store the second backup objects 250 representing the data stored in write cache 105 for the transient writes in the following manner. Instructions 122, when executed, may cause deduplication backup appliance 170 to copy, to second backup objects 170, the data representation(s) (e.g., data fingerprint(s)) of each portion of the first backup objects 200 that represent data of block device presentation 130 that is not written by any transient write whose data is stored in write cache 105. In such examples, instructions 122 may further cause the deduplication backup appliance 170 to store data representation(s) (e.g., data fingerprint(s)) of the data stored in write cache 105 for each transient write in the portion(s) of second backup objects 250 representing data of block device presentation 130 that are written by any of the transient write(s).

In such examples, to store the second backup objects 250 instructions 122, when executed, may read 186 the data representations (e.g., data fingerprints) of each of first backup objects 200 for block device presentation 130 from deduplication backup appliance 170, and may determine, based on the data stored in write cache 105 for transient write(s), which data representations (e.g., data fingerprints) from first backup objects 200 to replace in second backup objects 250 with data representations (e.g., data fingerprints) of the data stored in write cache 105 for the transient write(s) (as described above), and which data representations (e.g., data fingerprints) to copy from the first backup objects 200 to the second backup objects 205 (as described above). For example, for each data representation read from deduplication backup appliance 170, instructions 122 may determine, based on the data stored in write cache 105 for transient write(s), whether it is a data representation of a portion of the block device presentation 130 that has been written by a transient write. If so, then instructions 122 may cause deduplication backup appliance 170 to replace the data representation in the second backup objects 250 with a data representation of the data stored in write cache 105 for the transient write to the corresponding portion of the block device presentation 130. If not, then instructions 122 may cause the deduplication backup appliance 170 to copy the data representation from the first backup objects 200 to the second backup objects 250. While an individual determination may be made for each read data representation, the copy and replacement operations may be performed in groups.

In some examples, to cause the deduplication backup appliance to store the second backup objects, as described above, instructions 122, when executed, may read the data representations of each of the first backup objects 200 for the block device presentation from deduplication backup appliance 170, and determine, based on the data stored in write cache 105 for the transient write(s), which data representation(s) from first backup objects 200 to replace in second backup objects 250 with data fingerprint(s) of data stored in write cache 105, as described above. Based on the determinations, instructions 122 may cause deduplication backup appliance 170 to create and store second backup objects 250 such that they include copies of each of the data representations of the first backup objects 200 determined not to be replaced based on the data stored in write cache 105, and data representation(s) of data stored in write cache 105 to replace respective data representation(s) from the first backup objects 200.

As noted above, instructions 122 may receive, from client computing device 150, a request 184 to persistently store the data of transient write(s) 180 stored in write cache 105 for block device presentation 130.

In some examples, the request 184 may specify to persistently store the data in new snapshot. In such examples, in response to the request 184, instructions 122, when executed, may instruct a storage array 160 to create a child snapshot of an existing snapshot on storage array 160 that is represented by block device presentation 130. In the example of FIG. 1, instructions 122 may instruct storage array 160 to create a new child snapshot of snapshot virtual volume 164 (represented by block device presentation 130) on storage array 160. In such examples, instructions 122, when executed, may further apply the data stored in write cache 105 for prior transient write(s) to the created child snapshot.

In other examples, the request 184 may specify to persistently store the data in persistent storage associated with the backup agent. In such examples, in response to the request 184, instructions 122, when executed, may copy the data of each transient write for block device presentation 130 from write cache 105 to persistent storage 107 of a computing device implementing backup agent 121, such as persistent storage 107 of backup computing device 100. In some examples, the persistent storage 107 may be implemented by any non-volatile storage device(s) (e.g., flash device(s), solid state drive(s), or the like), or disk-based storage (e.g., one or more hard disk drives (HDDs)), or the like, or a combination thereof.

In the example of FIG. 1, client computing device 150 may be implemented by at least one computing device, which may include at least one physical network interface for communication on a computer network. Communications channel 151 may be implemented by a direct connection (e.g., wired or wireless, etc.) or by a connection via at least one computer network, or a combination thereof. In examples described herein, a computer network may include, for example, a local area network (LAN), a virtual LAN (VLAN), a wireless local area network (WLAN), a virtual private network (VPN), the Internet, or the like, or a combination thereof.

In the example of FIG. 1, storage array 160 may be a computing device comprising a plurality of storage devices and one or more controllers to interact with host devices and control access to the storage devices. In some examples, the storage devices may include hard disk drives (HDDs), solid state drives (SSDs), or any other suitable type of storage device, or a combination thereof. In some examples, the controller(s) may virtualize the storage capacity provided by the storage devices to enable a host to access a virtual volume made up of storage space from multiple different storage devices. For example, in the example of FIG. 1, controller(s) of storage array 160 may present base virtual volume 162 to client computing device 150.

In the example of FIG. 1, backup computing device 100 may be implemented by at least one computing device, which may include at least one physical network interface for communication on a computer network. Communications channel 161 may be implemented by a direct connection (e.g., wired or wireless, etc.) or by a connection via at least one computer network, or a combination thereof.

In the example of FIG. 1, deduplication backup appliance 170 may be implemented by at least one computing device comprising a plurality of storage devices and one or more controllers to interact with client devices and control access to the storage devices. In some examples, the storage devices may include hard disk drives (HDDs), solid state drives (SSDs), or any other suitable type of storage device, or a combination thereof.

In some examples, backup computing device 100 is separate from the deduplication backup appliance, the client computing device, and storage array 160, as illustrated in FIG. 1. In such examples, backup computing device 100 may communicate with deduplication backup appliance 170 via a communications channel 171 that may be implemented by a direct connection (e.g., wired or wireless, etc.) or by a connection via at least one computer network, or a combination thereof.

In other examples, backup agent 121, write cache 105, and persistent storage 107 may be implemented on deduplication backup appliance 170 (rather than on a computing device separate from deduplication backup appliance 170). In such examples, deduplication backup appliance 170 may comprise processing resource 110 and machine-readable storage medium 120 comprising instructions 122 to (at least partially) implement backup agent 121. In such examples, the computing device that implements the backup agent 121 may be the deduplication backup appliance 170.

As used herein, a “computing device” may be a server, storage device, storage array, desktop or laptop computer, switch, router, or any other processing device or equipment including a processing resource. In examples described herein, a processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. In examples described herein, the at least one processing resource 110 may fetch, decode, and execute instructions stored on storage medium 120 to perform the functionalities described above in relation to instructions stored on storage medium 120. In other examples, the functionalities of any of the instructions of storage medium 120 may be implemented in the form of electronic circuitry, in the form of executable instructions encoded on a machine-readable storage medium, or a combination thereof. The storage medium may be located either in the computing device executing the machine-readable instructions, or remote from but accessible to the computing device (e.g., via a computer network) for execution. In the example of FIG. 1, storage medium 120 may be implemented by one machine-readable storage medium, or multiple machine-readable storage media.

In other examples, the functionalities described above in relation to instructions of medium 120 may be implemented by one or more engines which may be any combination of hardware and programming to implement the functionalities of the engine(s). In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one of the engine(s). In some examples, the at least one machine-readable storage medium may store instructions that, when executed by the at least one processing resource, at least partially implement some or all of the engine(s). In such examples, a computing device at least partially implementing computing system 100 may include the at least one machine-readable storage medium storing the instructions and the at least one processing resource to execute the instructions. In other examples, the engine may be implemented by electronic circuitry.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard disk drive (HDD)), a solid state drive, any type of storage disc (e.g., a compact disc, a DVD, etc.), and the like, or a combination thereof. Further, any machine-readable storage medium described herein may be non-transitory. In examples described herein, a machine-readable storage medium or media may be part of an article (or article of manufacture). An article or article of manufacture may refer to any manufactured single component or multiple components.

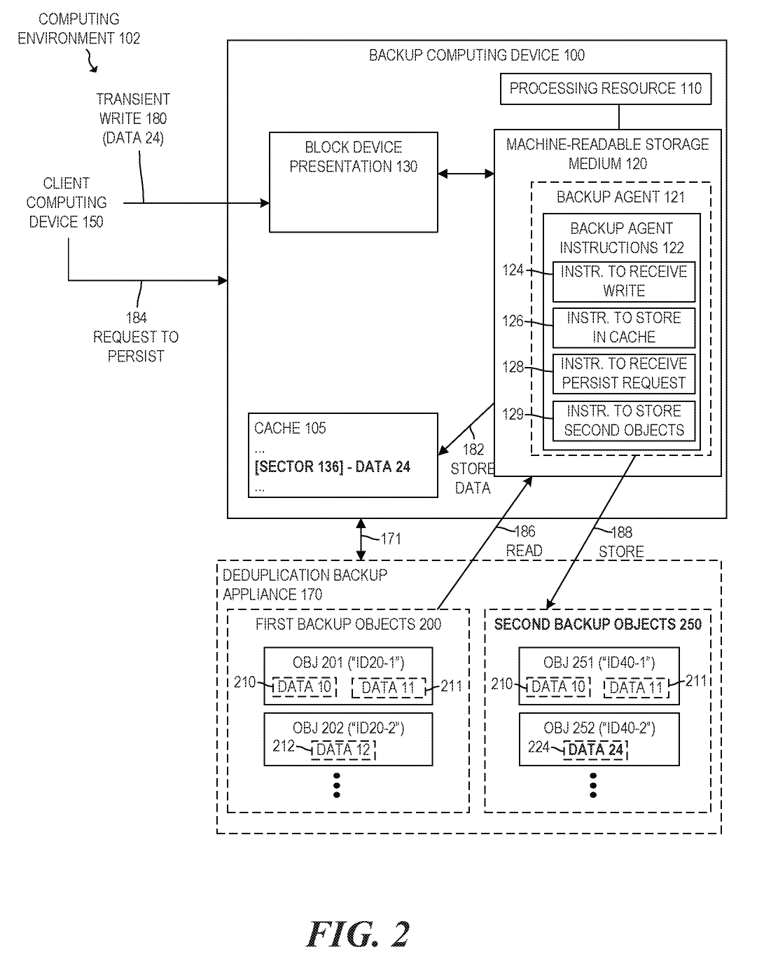

In some examples, instructions of medium 120 may be part of an installation package that, when installed, may be executed by processing resource 110 to implement the functionalities described above. In such examples, storage medium 120 may be a portable medium, such as a CD, DVD, or flash drive, or a memory maintained by a server from which the installation package can be downloaded and installed. In other examples, instructions of medium 120 may be part of an application, applications, or component(s) already installed on a computing device of computing environment 101 including processing resource 110. In such examples, the storage medium 120 may include memory such as a solid state drive, non-volatile memory device, or the like. In some examples, functionalities described herein in relation to FIG. 1 may be provided in combination with functionalities described herein in relation to any of FIGS. 2-4.

FIG. 2 is a block diagram of an example computing environment 102 including a backup computing device 100 to receive a request to persistently store the cached data of a transient write to a block device presentation. In the example of FIG. 2, computing environment 102 may include a backup computing device 100, as described in relation to FIG. 1, the backup computing device 100 including a processing resource 110, a machine-readable storage medium 120 comprising (e.g., storing) at least instructions 122 to at least partially implement functionalities of a backup agent 121, as described above, and a write cache 105 implemented in hardware, as described above. In the example of FIG. 2, backup computing device 100 may interact with a client computing device 150 (as described above) and a deduplication backup appliance 170, as described above.

In the example of FIG. 2, backup agent instructions 122 may include at least instructions 124, 126, 128, and 129, which, when executed by processing resource 110, may perform the functionalities described herein in relation to instructions 124, 126, 128, and 129. As described above in relation to FIG. 1, instructions 122, when executed, may present, to client computing device 150, a block device presentation of data represented by first backup objects 200 (that include data representations and are stored in deduplication backup appliance 170).

In the example of FIG. 2, instructions 124, when executed, may receive, from client computing device 150, transient write(s) 180 including data (e.g., data 24) to write to block device presentation 130, which is a block device presentation of data represented by first backup objects 200. In response to receiving the transient write(s) 180, instructions 126 may store 182, in write cache 105, the respective data (e.g., data 24) received in each transient write to block device presentation 130.

Instructions 128, when executed, may receive, from client computing device 150, a request 184 to persistently store the data of the at least one transient write stored in write cache 105 for the block device presentation. In some examples, the request may specify how to persistently store the data stored in write cache 105. In examples described herein, data is stored “persistently” when it is stored in a non-volatile storage medium.

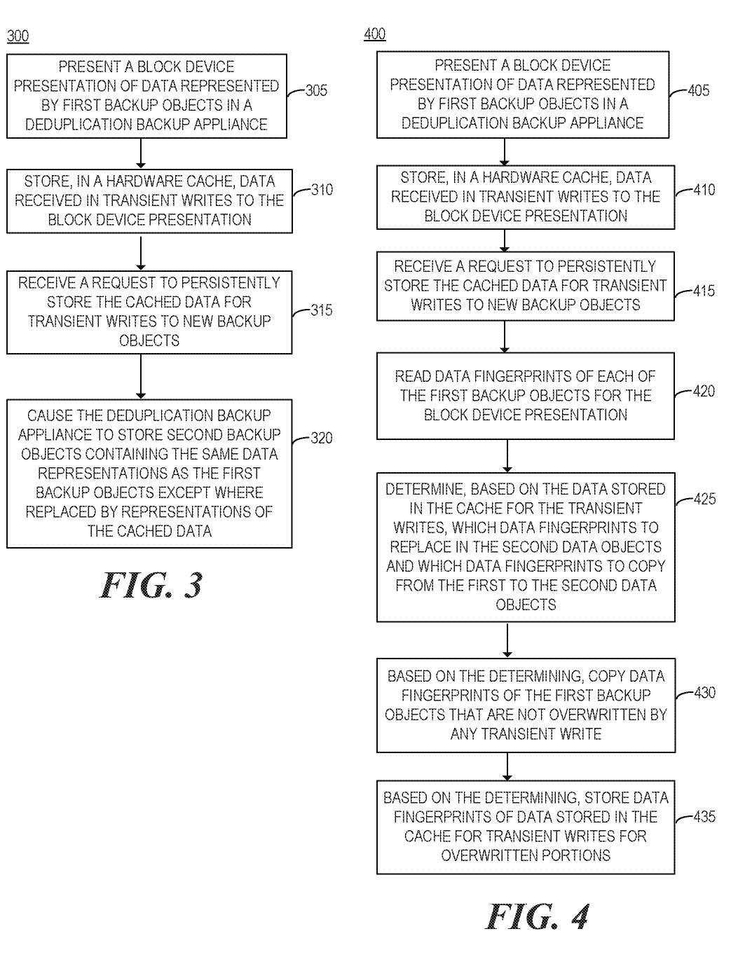

When the request 184 specifies to persistently store the data in new backup objects, instructions 129, when executed, may cause deduplication backup appliance 170 to store second backup objects 250 representing the data stored in write cache 105 for each transient write, such that second backup objects 250 contain the same data representations as first backup objects 200 except where replaced by at least one data representation of data stored in write cache 105 for a transient write (e.g., data 24), as described above in relation to FIG. 1. In some examples, functionalities described herein in relation to FIG. 3 may be provided in combination with functionalities described herein in relation to any of FIGS. 1, 2, and 4.

FIG. 3 is a flowchart of an example method 300 of a backup agent including causing a deduplication backup appliance to store backup objects representing data stored in cache for transient write(s). Although execution of method 300 is described below with reference to computing environment 101 of FIG. 1, other suitable environments for the execution of method 300 may be utilized (e.g., computing environment 102 of FIG. 2). Additionally, implementation of method 300 is not limited to such examples.

In the example of FIG. 3, method 300 may be performed by a backup agent 121 executed by at least one processing resource (e.g., performed by instructions 122 executed by processing resource 110, as described above in relation to FIG. 1.). At 305 of method 300, instructions 122 of backup agent 121, when executed, may present, to a client computing device 150, a block device presentation 130 of data represented by first backup objects 200 that include data representations and are stored in a deduplication backup appliance 170. At 310, instructions 122, when executed, may store, in a hardware write cache 105, data received in transient writes to the block device presentation 130. In such examples, the transient writes may be received from the client computing device 150.

At 315, instructions 122, when executed, may receive, from the client computing device 150, a request to persistently store, in new backup objects, the data stored in the write cache 105 for the transient writes to the block device presentation 130. At 320, in response to the request and based on the data stored in the write cache 105, instructions 122 of backup agent 121, when executed, may cause the deduplication backup appliance 170 to store second backup objects 250 representing the data stored in the write cache 105 for the transient writes, such that the second backup objects 250 contain the same data representations as the first backup objects 200 except where replaced by data representations of the data stored in the write cache 105 for the transient writes, as described above in relation to FIG. 1.

Although the flowchart of FIG. 3 shows a specific order of performance of certain functionalities, method 300 is not limited to that order. For example, the functionalities shown in succession in the flowchart may be performed in a different order, may be executed concurrently or with partial concurrence, or a combination thereof. In some examples, functionalities described herein in relation to FIG. 3 may be provided in combination with functionalities described herein in relation to any of FIGS. 1, 2, and 4.

FIG. 4 is a flowchart of an example method 400 of a backup agent including determining, based on data stored in a cache for transient writes, which data fingerprints from first backup objects to replace in second backup objects. Although execution of method 400 is described below with reference to computing environment 101 of FIG. 1, other suitable environments for the execution of method 400 may be utilized (e.g., computing environment 102 of FIG. 2). Additionally, implementation of method 400 is not limited to such examples.

In the example of FIG. 4, method 400 may be performed by a backup agent 121 executed by at least one processing resource (e.g., performed by instructions 122 executed by processing resource 110, as described above in relation to FIG. 1.). At 405 of method 400, instructions 122 of backup agent 121, when executed, may present, to a client computing device 150, a block device presentation 130 of data represented by first backup objects 200 that include data representations and are stored in a deduplication backup appliance 170. At 410, instructions 122, when executed, may store, in a hardware write cache 105, data received in transient writes to the block device presentation 130. In such examples, the transient writes may be received from the client computing device 150.

At 415, instructions 122, when executed, may receive, from the client computing device 150, a request to persistently store, in new backup objects, the data stored in the write cache 105 for the transient writes to the block device presentation 130. In such examples, instructions 122 of backup agent 121, when executed, do not apply, or cause the deduplication backup appliance to apply, the data of any transient write to the first backup objects 200 stored in deduplication backup appliance 170 at any time.

At 420, instructions 122, when executed, may read data fingerprints of each of the first backup objects 200 for the block device presentation from the deduplication backup appliance. At 425, instructions 122, when executed, may determine, based on the data stored in the write cache 105 for the transient writes, which data fingerprints from the first backup objects 200 to replace in the second backup objects 250 with data fingerprints of data stored in the write cache 105, and which data fingerprints to copy from the first backup objects 200 to the second backup objects 250.

At 430, based on the determining at 425, instructions 122, when executed, may copy, to the second backup objects 250, the data fingerprints of the first backup objects 200 that represent data of the block device presentation 130 that is not written by any of the received transient writes. At 435, and also based on the determining at 425, instructions 122, when executed, may store a data fingerprint of data stored in the write cache 105 for one of the received transient writes in each portion of the second backup objects 250 that represents data of the block device presentation 130 that is written by one of the received transient writes.

Although the flowchart of FIG. 4 shows a specific order of performance of certain functionalities, method 400 is not limited to that order. For example, the functionalities shown in succession in the flowchart may be performed in a different order, may be executed concurrently or with partial concurrence, or a combination thereof. In some examples, functionalities described herein in relation to FIG. 4 may be provided in combination with functionalities described herein in relation to any of FIGS. 1-3. All of the features disclosed in this specification (including any accompanying claims, abstract and drawings), and/or all of the elements of any method or process so disclosed, may be combined in any combination, except combinations where at least some of such features and/or elements are mutually exclusive.

What is claimed is:

1. An article comprising at least one non-transitory machine-readable storage medium comprising instructions at least partially implementing a backup agent, the instructions executable by at least one processing resource to:
receive, from a client computing device, at least one transient write including data to write to a block device presentation of data represented by first backup objects that include data representations and are stored in a deduplication backup appliance;
store, in a cache, the data received in each transient write to the block device presentation, wherein the block device presentation is presented to the client computing device by the backup agent;
receive, from the client computing device_{;} a request to persistently store the data of the at least one transient write stored in the cache for the block device presentation, the request specifying how to persistently store the data; and
when the request specifies to persistently store the data in new backup objects, cause the deduplication backup appliance to store second backup objects representing the data stored in the cache for each transient write, such that the second backup objects contain the same data representations as the first backup objects except where replaced by at least one data representation of data stored in the cache for a transient write.

2. The article of claim 1, wherein;
the instructions do not apply, or cause the deduplication backup appliance to apply, the data of any transient write to the first backup objects stored in the deduplication backup appliance; and
the backup agent is implemented on a backup computing device separate from the deduplication backup appliance and the client computing device.

3. The article of claim 1, wherein the backup agent is implemented on the deduplication backup appliance.

4. The article of claim 1, wherein the instructions to cause the deduplication backup appliance to store the second backup objects comprise instructions to cause the deduplication backup appliance to:
copy, to the second backup objects, the portions of the first backup objects representing data of the block device presentation that is not written by any of the at least one transient write; and
store a data fingerprint for the cached data of a received transient write in each portion of the second backup objects representing data of the block device presentation that is written by a transient write.

5. The article of claim 1, wherein:
the data representations of the first and second backup objects are data fingerprints of chunks of data; and
the instructions to cause the deduplication backup appliance to store the second backup objects comprise instructions to:
read the data fingerprints of each of the first backup objects for the block device presentation from the deduplication backup appliance;
determine, based on the data stored in the cache for the at least one transient write, which data fingerprints from the first backup objects to replace in the second backup objects with data fingerprints of data stored in the cache; and
based on the determination, cause the deduplication backup appliance to create and store the second backup objects including:
copies of each of the data fingerprints of the first backup objects determined not to be replaced based on the data stored in the cache_{;} and
at least one data fingerprint of data stored in the cache to replace at least one data fingerprint from the first backup objects.

6. The article of claim 1, wherein the instructions further comprise instructions to:
when the request specifies to persistently store the data in new snapshot:
instruct a storage array to create a child snapshot of an existing snapshot on the storage array represented by the block device presentation; and
apply the cached data of the transient writes to the child snapshot.

7. The article of claim 1, wherein the instructions further comprise instructions to:
when the request specifies to persistently store the data in persistent storage associated with the backup agent:
copy the data of each transient write from the cache to persistent storage of a computing device implementing the backup agent.

8. A method of a backup agent executed by at least one processing resource, the method comprising:
presenting, to a client computing device by the backup agent, a block device presentation of data represented by first backup objects that include data representations and are stored in a deduplication backup appliance;
storing, in a hardware cache_{;} data received in transient writes to the block device presentation_{;} the transient writes received from the client computing device;
receiving, from the client computing device, a request to persistently store, in new backup objects, the data stored in the cache for the transient writes to the block device presentation; and
in response to the request and based on the data stored in the cache, the backup agent causing the deduplication backup appliance to store second backup objects representing the data stored in the cache for the transient writes, such that the second backup objects contain the same data representations as the first backup objects except where replaced by data representations of the data stored in the cache for the transient writes.

9. The method of claim 8_{;} wherein the backup agent does not apply, or cause the deduplication backup appliance to apply, the data of any transient write to the first backup objects stored in the deduplication backup appliance at any time.

10. The method of claim 8, wherein causing the deduplication backup appliance to store second backup objects representing the data stored in the cache for the transient writes comprises:
reading data fingerprints of each of the first backup objects for the block device presentation from the deduplication backup appliance; and
determining, based on the data stored in the cache for the transient writes, which data fingerprints from the first backup objects to replace in the second backup objects with data fingerprints of data stored in the cache, and which data fingerprints to copy from the first backup objects to the second backup objects.

11. The method of claim 10, wherein causing the deduplication backup appliance to store second backup objects representing the data stored in the cache for the transient writes further comprises:
based on the determining:
copying, to the second backup objects, the data fingerprints of the first backup objects that represent data of the block device presentation that is not written by any of the received transient writes; and
in each portion of the second backup objects that represents data of the block device presentation that is written by one of the received transient writes, storing a data fingerprint of data stored in the cache for one of the received transient writes.

12. A computing device comprising:
at least one processing resource; and
at least one non-transitory machine-readable storage medium comprising instructions at least partially implementing a backup agent, the instructions executable by at least one processing resource to:
present, to a client computing device by the backup agent, a block device presentation of data represented by first backup objects that include data fingerprints and are stored in a deduplication backup appliance;
store, in a cache, data received in transient writes to the block device presentation, the transient writes received from the client computing device;
receive, from the client computing device, a request to persistently store, in new backup objects, the data of the transient writes stored in the cache for the block device presentation; and
in response to the request, store, in the deduplication backup appliance, second backup objects representing the data stored in the cache for the transient writes, by causing the deduplication backup appliance to:
copy, to the second backup objects, the data fingerprints of each portion of the first backup objects representing data of the block device presentation that is not written by any data stored in the cache for a transient write; and
in the portions of the second backup objects representing data of the block device presentation that is written by the transient writes, store data fingerprints of the data stored in the cache for the transient writes.

13. The computing device of claim 12, wherein:
the instructions do not apply, or cause the deduplication backup appliance to apply, the data of any transient write to the first backup objects at any time; and
the computing device is separate from the deduplication backup appliance and the client computing device.

14. The computing device of claim 12, wherein the instructions to store the second backup objects comprise instructions to:
read the data fingerprints of each of the first backup objects for the block device presentation from the deduplication backup appliance; and
determine, based on the data stored in the cache for the transient writes, which data fingerprints from the first backup objects to replace in the second backup objects with data fingerprints of the data stored in the cache for the transient writes, and which data fingerprints to copy from the first backup objects to the second backup objects.

15. The computing device of claim 12, wherein the computing device is the deduplication backup appliance.
